(19) United States
(12) Patent Application Publication
(10) Pub. No.: US 2011/0064016 A1
(43) Pub. Date: Mar. 17, 2011

(54) METHOD OF TRANSMITTING DATA OF MULTICAST BROADCAST SERVICE IN MOBILE WIRELESS CONNECTION SYSTEM

(75) Inventors: Eunkyung KIM, Seoul (KR); Jae Sun Cha, Daejeon-si (KR); Juhee Kim, Daejeon-si (KR); Soojung Jung, Daejeon-si (KR); Hyun Lee, Daejeon-si (KR); Kwang Jae Lim, Daejeon-si (KR); Chul Sik Yoon, Seoul (KR)

(73) Assignee: Electronics and Telecommunications Research Institute, Daejeon (KR)

(21) Appl. No.: 12/870,292

(22) Filed: Aug. 27, 2010

(30) Foreign Application Priority Data
Aug. 28, 2009 (KR) 10-2009-0080799
Aug. 27, 2010 (KR) 10-2010-0083284

(51) Int. Cl. H04H 20/71

(52) U.S. Cl. 370/312

(57) ABSTRACT

A method for receiving multicast broadcast service (MBS) data by a mobile station (MS) in a mobile wireless connection system which comprises receiving MBS-related information of at least one neighbor base station (BS) from a serving BS, performing handover from the serving BS to a target BS selected from the neighbor BSs, determining whether or not MBS-related information of the serving BS and MBS-related information of the target BS are identical, updating MBS-related information of the MS based on the determination results and receiving MBS data by using the updated MBS-related information of the MS, wherein the received MBS-related information of the neighbor BS comprises at least one of indication information indicating whether or not the MBS-related information of the neighbor BS and the MBS-related information of the serving BS are identical, information required to be updated among the MBS-related information of the serving BS, and every MBS-related information of the target BS is provided.

### CROSS-REFERENCE TO RELATED APPLICATIONS

This application claims the benefit of priority of Korean Patent Application No. 10-2009-0080799 filed on Aug. 28, 2009 and Korean Patent Application No. 10-2010-0083284 filed on Aug. 27, 2010, which are incorporated by reference in their entirety herein.

### BACKGROUND OF THE INVENTION

1. Field of the Invention

The present invention relates to an effective multicast broadcast service in a wireless access system and, more particularly, to a method for transmitting data of a multicast broadcast service.

2. Description of the Related Art

3GPP (3rd Generation Partnership Project) LTE (long term evolution) and IEEE (Institute of Electrical and Electronics Engineers) 802.16m is being developed as a candidate of a next-generation wireless communication system. The 802.16m standard involves two aspects of continuity of the past of modification of the existing 802.16e standard and continuity of the future of a standard for a next-generation IMT-Advanced system. Thus, the 802.16m standard is required to meet advanced requirements for the IMT-Advanced system while maintaining compatibility with the 802.16e standard-based mobile WiMAX system.

In general, a wireless communication system uses one bandwidth for a data transmission. For example, a 2^{nd}-generation wireless communication system uses a bandwidth of 200 KHz to 1.25 MHz, and a 3^{rd}-generation wireless communication system uses a bandwidth of 5 MHz to 10 MHz. In order to support an increasing transmission capacity, the recent 3GPP LTE or 802.16m extends the bandwidth to 20 MHz or higher. The extension of the bandwidth to increase the transmission capacity seems inevitable, but the support of a large bandwidth even for a case in which a required service level is low causes unnecessary power consumption.

The IEEE 802.16m system supports an enhanced multicast broadcast service (E-MBS). The E-MBS is a point-to-multipoint system in which data packets are simultaneously transmitted from one source to a plurality of destinations. Broadcasting refers to the capability of transmitting contents to every user. Multicasting refers to contents destined for a particular group of users subscribed to receive a particular service. Static multicasting and dynamic multicasting may be supported. In the following description, a part described as the MBS can be combined with the E-MBS and used, which is expressed as the MBS only in the present disclosure.

Meanwhile, in order to overcome the limitation in a service area and the limitation in the reception capacity of users, a wireless communication system divides a service area into a plurality of cells to provide a communication service. This is called a multi-cell environment. A cell is an area to which a base station (BS) provides a communication service. One BS may provide a service to at least one cell. A mobile station (MS) belongs to one cell. A cell to which the MS belongs is called a serving cell. A different cell neighboring the serving cell is called a neighbor cell.

The wireless communication system is different from a wired communication system in that it can and is supposed to seamlessly provide a service to MSs having mobility. Namely, when the MS moves from the serving cell to a neighbor cell, in order for the MS to continuously receive the service, the neighbor cell to which the MS has moved should be changed into a serving cell. The procedure of changing the serving cell of the MS due to the movement of the MS is called handover. In general, one BS administers one cell, and the procedure of changing the serving cell of the MS is the same as the procedure of changing a serving BS of the MS. Thus, hereinafter, the procedure of changing a serving BS will now be described. A new cell to which the MS has moved is called a target cell, and a BS providing a communication service to the target cell is called a target BS. A BS currently providing a communication service is called a serving BS.

In one MBS zone, a user should be able to receive an MBS service regardless of a connected state such as a normal mode or a sleep mode or an idle state. Namely, in order to receive the MBS service, the user is to receive the MBS service without having to perform an additional registration or an additional procedure. Also, when the user moves from a particular MBS zone to a different zone, the user should be able to continuously receive the service regardless of his state.

Thus, a method for continuously providing an MBS service to the user when handover is performed while the user is in a connected state or in an idle state is required.

### SUMMARY OF THE INVENTION

Therefore, an object of the present invention is to provide a method for transmitting optimized multicast broadcast service (MBS) data in a connected state or in an idle state.

In one aspect, a method for receiving multicast broadcast service (MBS) data by a mobile station (MS) in a mobile wireless connection system comprises receiving MBS-related information of at least one neighbor base station (BS) from a serving BS, performing handover from the serving BS to a target BS selected from the neighbor BSs, determining whether or not MBS-related information of the serving BS and MBS-related information of the target BS are identical, updating MBS-related information of the MS based on the determination results and receiving MBS data by using the updated MBS-related information of the MS, wherein the received MBS-related information of the neighbor BS comprises at least one of indication information indicating whether or not the MBS-related information of the neighbor BS and the MBS-related information of the serving BS are identical, information required to be updated among the MBS-related information of the serving BS, and every MBS-related information of the target BS.

In another aspect, a method for providing a multicast broadcast service by a serving base station in a mobile wireless connection system comprises determining whether or not MBS-related information of the serving BS and MBS-related information of a target BS are identical and transmitting MBS-related information of the serving BS to a mobile station, wherein the MBS-related information of the serving BS comprises at least one of indication information indicating whether or not the MBS-related information of the target BS and the MBS-related information of the serving BS are identical, information required to be updated among the MBS-related information of the serving BS, and every MBS-related information of the target BS.

In another aspect, a method for receiving multicast broadcast service data by a mobile station in a mobile wireless connection system comprises when the MS is in an idle state, transmitting, by the MS, a ranging-related message including information indicating ranging for performing updating of an MBS location from a serving base station to a target BS, to the target BS, receiving a ranging response message including MBS-related information of the target BS, updating MBS-related information of the MS based on the MBS-related information of the target BS and receiving MBS data by using the updated MBS-related information of the MS, wherein the MBS-related information of the target BS comprises indication information indicating whether or not the MBS-related information of the neighbor BS and the MBS-related information of the serving BS are identical.

According to exemplary embodiments of the present invention, an MBS service can be effectively and continuously provided in a mobile wireless access system. When handover is performed between MBS zones, an MBS service can be provided through MBS-related information regardless of a connected state or an idle state of a mobile station (MS).

### BRIEF DESCRIPTION OF THE DRAWINGS

FIG. 1 illustrates a wireless communication system.

FIG. 2 is a flow chart illustrating the process of performing in a connected state by the MS and updating MBS-related information.

FIG. 3 is a flow chart illustrating the process of whether to perform updating according to whether or not the MBS-related information is identical.

FIG. 4 is a flow chart illustrating the process of a method for receiving MBS data through MBS location updating when the MS in an idle state moves between MBS zones.

FIG. 5 is a flow chart illustrating the process of updating the MBS location in an idle state according to an exemplary embodiment of the present invention.

FIG. 6 is a flow chart illustrating the process of updating an MBS location in an idle state according to another exemplary embodiment of the present invention.

FIG. 7 is a flow chart illustrating the process of updating an MBS location in an idle state according to still another exemplary embodiment of the present invention.

FIG. 8 is a flow chart illustrating the process of updating an MBS location in an idle state according to yet another exemplary embodiment of the present invention.

### DETAILED DESCRIPTION OF THE INVENTION

Exemplary embodiments of the present invention will now be described in detail with reference to the accompanying drawings. The same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms.

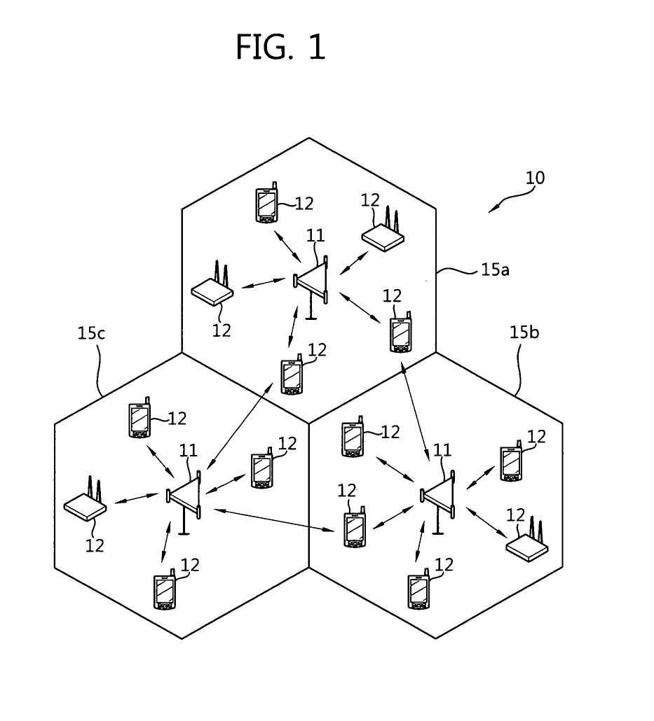

FIG. 1 illustrates a wireless communication system. With reference to FIG. 1, the wireless communication system 10 includes at least one base station (BS). Each BS 11 provides a communication service to particular geographical areas (which is generally called cells) 15a, 15b, and 15c. The cells may be divided into a plurality of areas (which is generally called sectors). A mobile station (MS) 12 may be fixed or mobile and may be referred to by other names such as user equipment (UE), mobile terminal (MT), user terminal (UT), subscriber station (SS), wireless device, personal digital assistant (PDA), wireless modem, handheld device, etc. The BS 11 generally refers to a fixed station that communicates with the MS 12 and may be called by other names such as evolved-node B (eNB), base transceiver system (BTS), access point (AP), etc. Hereinbelow, downlink (DL) refers to communication from the BS 11 to the MS 12, and uplink (UL) refers to communication from the MS 12 to the BS 11. In the downlink, a transmitter may be a part of the BS 11 and a receiver may be a part of the MS 12. In the uplink, a transmitter may be a part of the MS 12 and a receiver may be a part of the BS 11. A packet flow of uplink or downlink between the BS 11 and the MS 12 is called a service flow.

An MBS has a particular quality of service (QoS) and one service flow and is simultaneously mapped to several users to provide an MBS service. Users that are to receive the MBS service set a parameter and a service flow to receive the corresponding MBS service. The BS providing the MBS service belong to a particular MBS zone, and in each MBS zone, common content transmitted to the corresponding service flow are discriminated by an E-MBS ID and transmitted. The E-MBS ID is a common ID assigned for a corresponding user to receive the MBS service. In this case, the MBS content are transmitted to an area discriminated as a single zone, and an MBS zone is discriminated as a unique corresponding MBS zone ID. The content has the same channel or service flow ID (FID). In this case, the FID exists as a pair with a corresponding E-MBS ID, which are allocated to each MBS connection. A user may be assigned several FIDs, and MBS content belonging to one E-MBS ID is discriminated by the FID and transmitted.

Hereinafter, a method for providing an MBS service in a connected state or an idle state will be described.

First, the case in which the MS is in a connected state will now be described.

In a connected state, as the MS, which receives an MBS service, moves its location, the MS performs handover. A BS currently providing the MBS service is called a serving BS, and a BS from which the MS is to receive the MBS service or a different service after performing handover is called a target BS. MBS-related information of the serving BS and MBS-related information of the target BS may be compared to determine whether or not the handover is performed between different MBS zones or within an MBS zone.

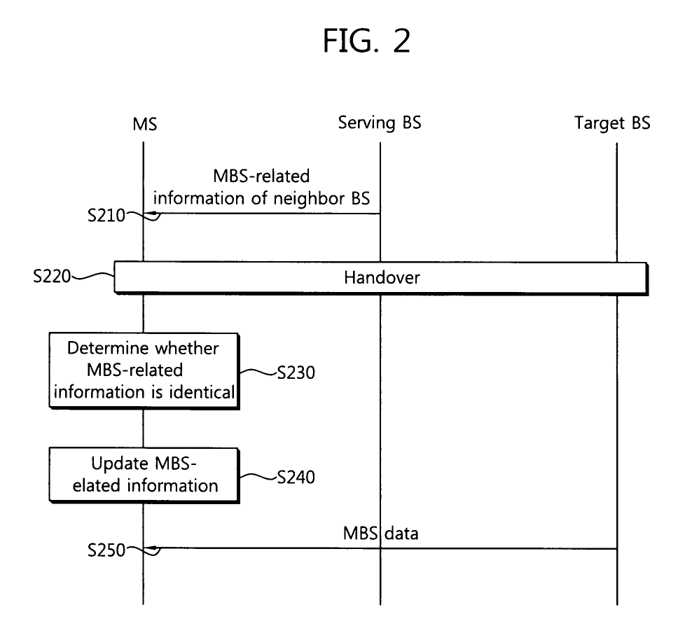

FIG. 2 is a flow chart illustrating the process of performing in a connected state by the MS and updating MBS-related information.

As shown in FIG. 2, the serving BS transmits MBS-related information of a neighbor BS which is likely to be a target BS to the MS (S210). In this case, the serving BS may transmit only indication information indicating whether or not the MBS-related information of the serving BS and that of the target BS, without having to transmit the entirety of the MBS-related information. When the MBS-related information is identical, the existing MBS-related information may be used as it is, so there is no need to receive every MBS-related information of the neighbor BS. The size of the indication information is far smaller than the amount of information when the entirety of the MBS-related information is transmitted, so the amount of data can be reduced.

Every MBS-related information required for the MBS service among the MBS-related information of the neighbor BS may be transmitted, only a partial information required to be updated among the MBS-related information may be transmitted, or the information may be mixedly transmitted. Update indication information indicating information required to be updated of each of the MBS-related information may be transmitted. Whether or not each of the MBS-related information is identical is determined, and when each MBS-related information is identical, there is no need to transmit each MBS-related information.

The representative MBS-related information that may be updated may include an MBS zone ID, an E-MBS ID, an FID, and the like. The MBS-related information is entirely updated, or only a portion of the MBS-related information may be updated as necessary. Transmission of the indication information may be made through various methods. Namely, the indication information may be included in a neighbor advertisement message (AAI_NBR-ADV in 802.16m of IEEE) and transmitted, may be additionally included in a new MBS-related message and transmitted, may be added to an existing MBS-related message and transmitted, or may be transmitted through a MAC header or a dedicated channel.

In order to receive the data from the target BS, the MS performs handover from the serving BS to the target BS (S220). After performing handover, the MS should configure MBS-related information in order to receive MBS data. The MS can obtain the MBS-related information of the target BS from the received MBS-related information of the neighbor BS, and in this case, the MS compares the MBS-related information of the target BS with the MBS-related information of the existing serving BS to check whether they are identical (S230). In this case, besides the comparison between the MBS-related information, if indication information regarding whether or not the MBS-related information is identical is directly received from the serving BS, the MS may use the indication information, and in this case, the determining process is rapidly performed.

When the MBS-related information of the target BS is not identical to the MBS-related information of the serving BS, the MS updates the MBS-related information (S240). When the MS receives only the indication information, the MS should additionally receive MBS-related information for updating. The MS may perform updating on the basis of the MBS-related information of the target BS included in the MBS-related information of the neighbor BS. When the MBS-related information of the target BS is identical to the MBS-related information of the serving BS, updating is not necessary, so the MBS-related information is set to be identical to the MBS-related information of the existing serving BS. The MS receives MBS data from the target BS on the basis of the updated MBS-related information (S250) and continuously perform the MBS service.

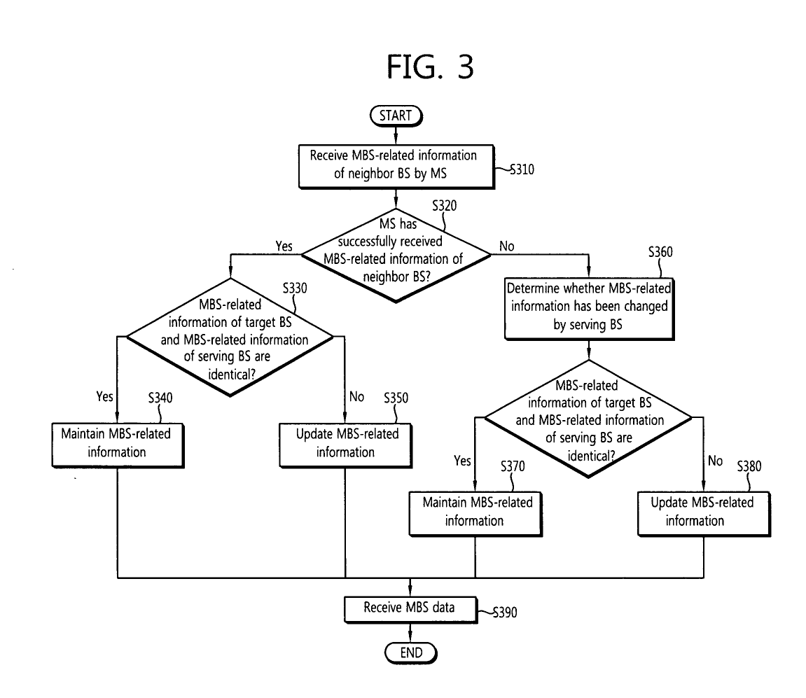

FIG. 3 is a flow chart illustrating the process of whether to perform updating according to whether or not the MBS-related information is identical.

With reference to FIG. 3, the MS receives the MBS-related information of the neighbor BS from the serving BS (S310). In this case, the reception of the MBS-related information of the neighbor BS may fail, so it is determined whether or not the MS has successfully received the MBS-related information of the neighbor BS (S320).

When the MBS-related information of the neighbor BS has been successfully received, the MS compares the MBS-related information of the target BS, which has been selected from among neighbor BSs and to which the MS has performed handover, with the MBS-related information of the serving BS (S330). In particular, the MS may compare information regarding an MBS zone. The reason is because if information regarding an MBS zone having the same MBS zone ID is identical, other MBS-related information such as an E-MBS ID or an FID is identical in many cases.

When the MS performs handover within the same MBS zone, the MS, which receives the MBS service through the serving BS, does not need to update the MBS-related information in most cases, so the MS maintains the MBS-related information of the serving BS as it is (S340). The MBS-related information of the serving BS may be included in a handover-related message and transmitted in the process of handover. Meanwhile, when the MS performs handover between different MBS zones, the MS, which receives the MBS service through the serving BS, may need to update the MBS-related information. In this case, the MS may perform updating with the MBS-related information of the new target BS from the MBS-related information of the existing serving BS (S350). In addition, the MBS-related information of the target BS may be included in a handover-related message and transmitted in the course of handover.

Meanwhile, the MS may fail to successfully receive the MBS-related information of the neighbor BS. When the MS fails to receive the MBS-related information of the neighbor BS in advance, it may not be able to update the MBS-related information of the target BS through the existing handover-related message. This also happens when the BS fails to predict handover of the MS. In this case, the MS includes the MBS-related information of the existing serving BS in the handover-related message in performing handover. The target BS compares its MBS-related information and the received MBS-related information of the serving BS to check whether they are identical (S360).

When the MBS-related information of the target BS and the MBS-related information of the serving BS are identical, the MS maintains the MBS-related information without having to update it (S370). If, however, the MBS-related information of the target BS and the MBS-related information of the serving BS are not identical, the MS updates the MBS-related information (S380).

In this manner, when the MS fails to receive the MBS-related information of the neighbor BS, the MS performs unprepared handover because it does not have the MBS-related information of the target BS. After performing handover, when the MS performs ranging with the target BS, the MS includes information indicating that it has performed unprepared handover during the MBS service and updating of the MBS-related information is required, in a ranging-related message, and transmits the same to the BS. For example, a message such as ‘unprepared handover with MBS service’ may be included in the ranging-related message. In this case, the MS may provide MBS-related information of the currently received MBS-related service. Upon receiving the ranging-related message, the BS may transmit MBS-related information to be updated along with a ranging response message to the MS, so that the MS can perform updating and continuously perform the MBS service.

When the MS completes the configuration of the MBS-related information by maintaining or updating the MBS-related information, it receives MBS data on the basis of the configured MBS-related information (S390).

The BS can receive MBS-related information according to various methods. Namely, the methods include a method of including the MBS-related information in a handover-related message and updating it in performing handover, a method of receiving the MBS-related information before, while, or after performing handover by newly adding an MBS-related message, a method of receiving the MBS-related information through a MAC header, a method of receiving MBS-related information through a control channel, a method of receiving the MBS-related information in performing ranging with the target BS after performing handover, and the like. These methods may be independently performed, or one or more of them may be combined to be performed together.

When the MBS-related information of the neighbor BS is provided through a neighbor advertisement message, it may be transmitted to every MBS-related MS of the neighbor BS, and in this case, when a message is newly added or when handover is performed, the MBS service may be received without having to update the MBS-related information of the target BS. In this case, however, when a portion of the MBS-related information is informed or only whether or not the MBS-related information of the serving BS and the MBS-related information of the target BS are identical is informed, namely, when only indication information is transmitted, the MBS-related information is updated when handover is performed.

When the serving BS and the target BS provide the MBS service in the same MBS zone, the same MBS zone information may be used and updating may not be necessary. However, updating of information regarding every MBS zone excluding the MBS zone ID may be required or updating of only the information regarding some MBS zones may be required. Meanwhile, when the serving BS and the target BS provide the MBS service in different MBS zones, only the MBS zone IDs may be simply different and the other MBS-related information may not need to be updated. However, updating of the information regarding every MBS zone including the MBS zone ID may be required, or updating of the information regarding some MBS zones including the MBS zone ID may be required.

Second, the case in which the MS is in an idle state will now be described.

When the MS in an idle state moves between MBS zones, the MS may transition to a connected state and perform the handover process as described above. Or, without transitioning to the connected state, the MS may perform MBS location updating to update the MBS-related information and continuously receive the MBS service.

MBS location updating is performed when there is no mapping information regarding the MBS zone regarding a BS for which location updating is desired to be performed, an E-MBS ID, and the like.

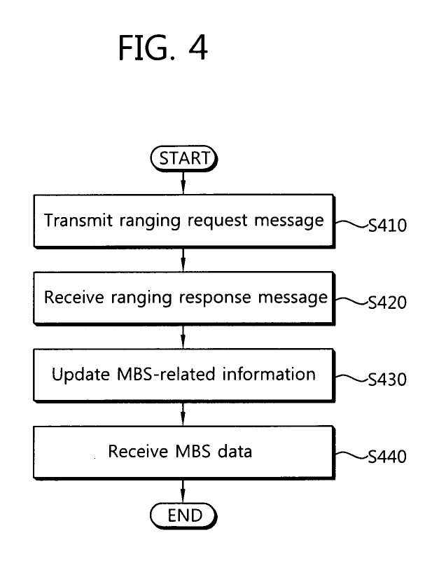

FIG. 4 is a flow chart illustrating the process of a method for receiving MBS data through MBS location updating when the MS in an idle state moves between MBS zones.

As shown in FIG. 4, the MS, which wants to perform MBS location updating, transmits a ranging request message (S410). In this case, the ranging request message may include information indicating that the purpose of ranging is to update the MBS location for the MBS service. The MS receives a ranging response message including the MBS-related information regarding an MBS desire to be received from the BS (S420). In this case, the MBS-related information may include an E-MBS ID, an MBS zone ID, an FID, and the like. The MBS-related information of the MS is updated on the basis of the received MBS-related information (S430).

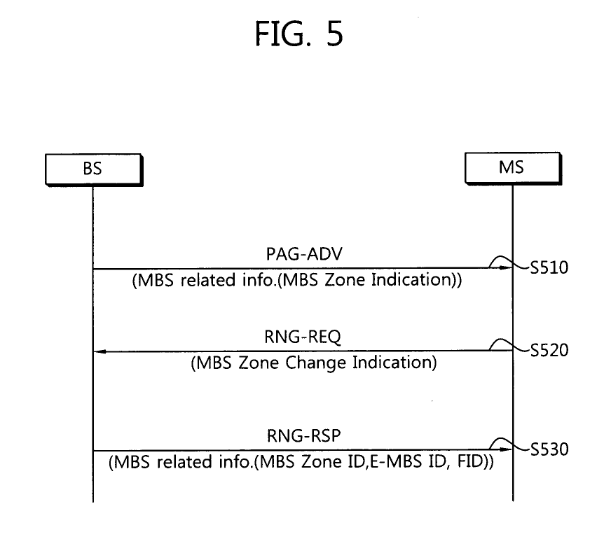

FIG. 5 is a flow chart illustrating the process of updating the MBS location in an idle state according to an exemplary embodiment of the present invention.

As discussed above, in order to update the MBS location, the MS should transmit a ranging request message and receive a ranging response message. Beforehand, the MS may receive a paging advertisement message (PAG-ADV) from the BS (S510). The PAG-ADV message may include MBS-related information that the MS is currently receives the service, and particular, the PAG-ADV message generally includes MBS zone information. Subsequently, the MS transmits a ranging request message (RNG-REQ) to the BS. In this case, the MS may include indication information indicating whether or not the MBS zone received from the BS is identical to the existing MBS zone or indication information indicating that the MBS needs to be updated in the ranging request message, and transmit the same (S520). Thereafter, the MS receives a ranging response message (RNG-RSP) from the BS. The RNG-RSP message includes MBS-related information which has requested by the MS (S530). The MBS-related information may include an E-MBS ID, an FID, an MBS zone ID, and the like. When the MBS-related information is identical through the indication information which has been transmitted by the MS, the BS does not need to include every MBS-related information in the RNG-RSP, but when the MBS-related information is not identical according to the indication information which has been transmitted by the MS, the BS transmits MBS-related information required to be updated or every MBS-related information.

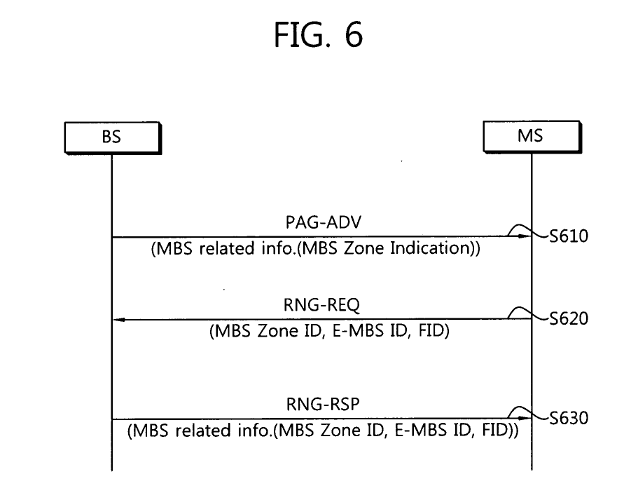

FIG. 6 is a flow chart illustrating the process of updating an MBS location in an idle state according to another exemplary embodiment of the present invention.

In the exemplary embodiment of FIG. 6, the BS transmits a PAG-ADV message to the MS (S610), similarly to the exemplary embodiment of FIG. 5. In this case, however, indication information is not included in the RNG-REQ message, but every MBS-related information or only information to be updated is included in the RNG-REQ message (S620). In this case, the MS transmits the every MBS-related information, and the BS itself compares the MBS-related information of the BS and the MBS-related information of the existing MS to check whether or not they are identical, showing a difference from the former exemplary embodiment. Subsequently, the BS transmits the MBS-related information to the MS so that the MBS-related information can be updated (S630).

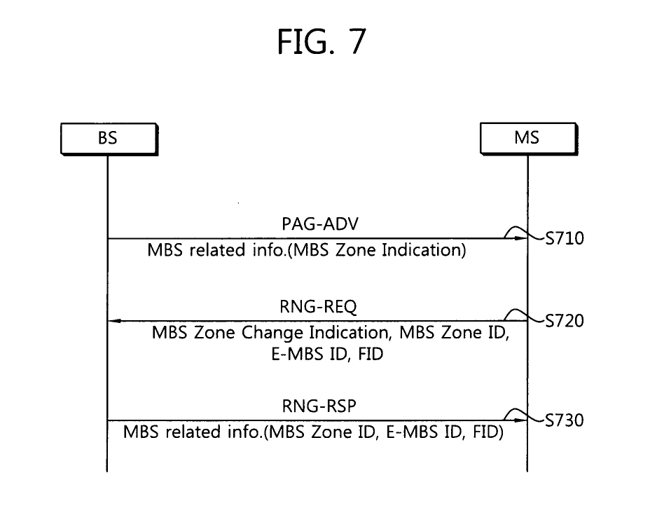

FIG. 7 is a flow chart illustrating the process of updating an MBS location in an idle state according to still another exemplary embodiment of the present invention.

In the exemplary embodiment of FIG. 7, the BS transmits a PAG-ADV message to the MS (S710), similarly to the exemplary embodiment of FIG. 5. In this case, however, not only the indication information is included in the RNG-REQ message, but also the MBS-related information (E-MIS ID, FID, and MBS zone ID) is further included in the RNG-REQ message (S720). In this case, the BS may determine whether or not the MBS-related information is identical through the indication information received from the MS or the BS itself may determine whether or not the MBS-related information of the BS and the MBS-related information of the existing MS are identical, showing a difference from the former exemplary embodiment. Subsequently, the BS transmits the MBS-related information to the MS so that the MBS-related information can be updated (S730).

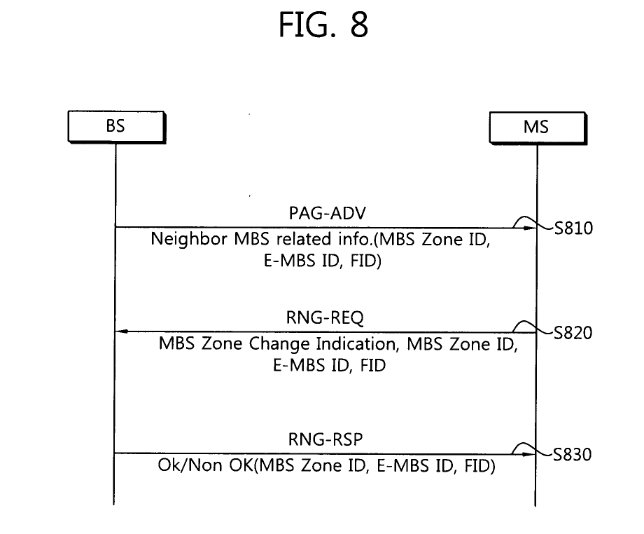

FIG. 8 is a flow chart illustrating the process of updating an MBS location in an idle state according to yet another exemplary embodiment of the present invention.

With reference to FIG. 8, the BS transmits MBS-related information of a neighbor BS to the MS (S810). The MS transmits indication information indicating whether or not the MBS-related information of the neighbor BS is identical to its MBS-related information to the BS and also transmits MBS-related information (the E-MBS ID, the FID, and the MBS zone ID) together (S820). Then, the BS transmits an OK message or a NON OK message indicating whether or not it is okay to maintain the existing MBS-related information on the basis of the indication information which has been received from the MS, to indicate whether or not updating is required. Here, the OK message is transmitted when updating is not required, and the NON OK message is transmitted when updating is required. As for the OK or NON OK message, when a corresponding bitmap is set to 1 in the form of a bitmap, updating is required, and when the corresponding bitmap is set to 0, the MS already has the information to be updated or updating is not required.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for receiving multicast broadcast service (MBS) data by a mobile station (MS) in a mobile wireless connection system, the method comprising;
receiving MBS-related information of at least one neighbor base station (BS) from a serving BS;
performing handover from the serving BS to a target BS selected from the neighbor BSs;
determining whether or not MBS-related information of the serving BS and MBS-related information of the target BS are identical;
updating MBS-related information of the MS based on the determination results; and
receiving MBS data by using the updated MBS-related information of the MS,
wherein the received MBS-related information of the neighbor BS comprises at least one of indication information indicating whether or not the MBS-related information of the neighbor BS and the MBS-related information of the serving BS are identical, information required to be updated among the MBS-o related information of the serving BS, and every MBS-related information of the target BS.

2. The method of claim 1, wherein the received MBS-related information of the neighbor BS further comprises update indication information indicating whether or not there is information required to be updated among the MBS-related information of the serving BS, and the information required to be updated is updated by using the update indication information.

3. The method of claim 1, wherein the indication information indicates whether or not an MBS zone ID among the MBS-related information of the neighbor BS is identical to an MBS zone ID of the serving BS.

4. The method of claim 1, wherein when the MBS-related information of the target BS and the MBS-related information of the serving BS are identical, the handover-related message transmitted in performing the handover further comprises the MBS-related information of the serving BS, and the MBS-related information of the MS are maintained as the MBS-related information of the serving BS

5. The method of claim 1, wherein when the MBS-related information of the target BS and the MBS-related information of the serving BS are not identical, the handover-related message transmitted in performing the handover further comprises the MBS-related information of the target BS, and the MBS-related information of the MS is updated based on the MBS-related information of the target BS.

6. The method of claim 1, wherein the MBS-related information of the serving BS, the MBS-related information of the target BS, the MBS-related information of the neighbor BS, and the MBS-related information of the MS comprise at least one of an MBS zone ID, an E-MBS ID, and a flow ID (FID), respectively.

7. The method of claim 1, wherein when the MS fails to receive the MBS-related information of the neighbor BS, the handover-related message transmitted in performing the handover comprises the MBS-related information of the serving BS, and the method further comprising:
receiving indication information indicating whether or not the MBS-related information of the target BS and the MBS-related information of the serving BS are identical from the serving BS.

8. A method for providing a multicast broadcast service (MBS) by a serving base station in a mobile wireless connection system, the method comprising:
determining whether or not MBS-related information of the serving BS and MBS-related information of a target BS are identical; and
transmitting MBS-related information of the serving BS to a mobile station (MS),
wherein the MBS-related information of the serving BS comprises at least one of indication information indicating whether or not the MBS-related information of the target BS and the MBS-related information of the serving BS are identical, information required to be updated among the MBS-related information of the serving BS, and every MBS-related information of the target BS.

9. The method of claim 8, wherein the MBS-related information of the serving BS, the MBS-related information of the target BS, the MBS-related information of the neighbor BS, and the MBS-related information of the MS comprise at least one of an MBS zone ID, an E-MBS ID, and a flow ID (FID), respectively.

10. The method of claim 8, wherein the indication information is included in at least one of a MAC management message, an MBS-related message, a MAC header, and a dedicated channel, and transmitted.

11. A method for receiving multicast broadcast service data by a mobile station in a mobile wireless connection system, the method comprising:
when the MS is in an idle state, transmitting, by the MS, a ranging-related message including information indicating ranging for performing updating of an MBS location from a serving base station (BS) to a target BS, to the target BS;
receiving a ranging response message including MBS-related information of the target BS;
updating MBS-related information of the MS based on the MBS-related information of the target BS; and
receiving MBS data by using the updated MBS-related information of the MS,
wherein the MBS-related information of the target BS comprises indication information indicating whether or not the MBS-related information of the neighbor BS and the MBS-related information of the serving BS are identical.

12. The method of claim 11, further comprising:
receiving a paging advertisement message from the BS including MBS zone information of the target BS, before the ranging-related message is transmitted to the target BS.

13. The method of claim 11, wherein the MBS-related information of the target BS, the MBS-related information of the neighbor BS, the MBS-related information of the serving BS, and the MBS-related information of the MS comprise at least one of an E-MBS ID, an MBS zone ID, and a flow ID (FID), respectively.
